(19) United States
(12) Patent Application Publication
(10) Pub. No.: US 2011/0138333 A1
(43) Pub. Date: Jun. 9, 2011

(54) Room User Interface

(76) Inventors: Ravishankar Gundlapalli, San Jose, CA (US); Subashree Krishnan, Sunnyvale, CA (US)

(21) Appl. No.: 12/630,802

(22) Filed: Dec. 3, 2009

(51) Int. Cl. G06F 3/048

(52) U.S. Cl. 715/839

(57) ABSTRACT

Disclosed is a method, comprising a) generating a user interface having a background, wherein the background resembles a room, and wherein the user interface includes graphical icons resembling real-world objects; and b) associating each graphical icon with a task, wherein when a graphical icon is selected utilizing a selection technique, the task associated with the selected graphical icon is performed.

### FIELD

The present disclosure relates to a user interface.

### BACKGROUND

Electronic devices with display screens generally display a user interface so that a user may operate the electronic devices to do certain tasks. For example, an electronic device such as a computer or a mobile phone has a user interface which is displayed on a display screen. The user interface generally has a plurality of graphical icons which are associated with a plurality of tasks. A graphical icon may be selected on the display screen to perform a certain task.

Conventional user interfaces are quite complex and need a great deal of effort from a user to understand to operate or navigate through the electronic devices.

### SUMMARY

In one aspect, the present disclosure provides a method, comprising a) generating a user interface having a background, wherein the background resembles a room, and wherein the user interface includes graphical icons resembling real-world objects; and b) associating each graphical icon with a task, wherein when a graphical icon is selected utilizing a selection technique, the task associated with the selected graphical icon is performed.

In another aspect, the present disclosure provides a system comprising a) display screen; and b) a processor couple to the display screen, the processor comprising: a user interface generating module for generating a user interface having a background, wherein the background resembles a room, and wherein the user interface includes graphical icons resembling real-world objects; and a task associating module for associating each graphical icon with a task, wherein when a graphical icon is selected utilizing a selection technique, the task associated with the selected graphical icon is performed.

In yet another aspect of the present disclosure, the present disclosure provides computer-implemented methods, computer systems and a computer readable medium containing a computer program product, comprising: a) program code for generating a user interface having a background, wherein the background resembles a room, and wherein the user interface includes graphical icons resembling real-world objects; and b) program code for associating each graphical icon with a task, wherein when a graphical icon is selected utilizing a selection technique, the task associated with the selected graphical icon is performed.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

FIG. 1 shows a block diagram of a system for generating a user interface, in accordance with an embodiment of the present disclosure; and

FIG. 2 is a flow chart representing a method for generating a user interface, in accordance with an embodiment of the present disclosure.

The method and system have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Before describing in detail embodiments that are in accordance with the present disclosure, it should be observed that the embodiments reside primarily in combinations of method steps and system components related to generating a user interface.

As used herein, relational terms such as first and second, and the like may be used solely to distinguish one module or action from another module or action without necessarily requiring or implying any actual such relationship or order between such modules or actions. The terms “comprises,” “comprising,” or any other variation thereof, are intended to cover a non-exclusive inclusion, such that a process, method, article, or apparatus that comprises a list of elements that does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Any embodiment described herein is not necessarily to be construed as preferred or advantageous over other embodiments. All of the embodiments described in this detailed description are illustrative, and provided to enable persons skilled in the art to make or use the disclosure and not to limit the scope of the disclosure, which is defined by the claims.

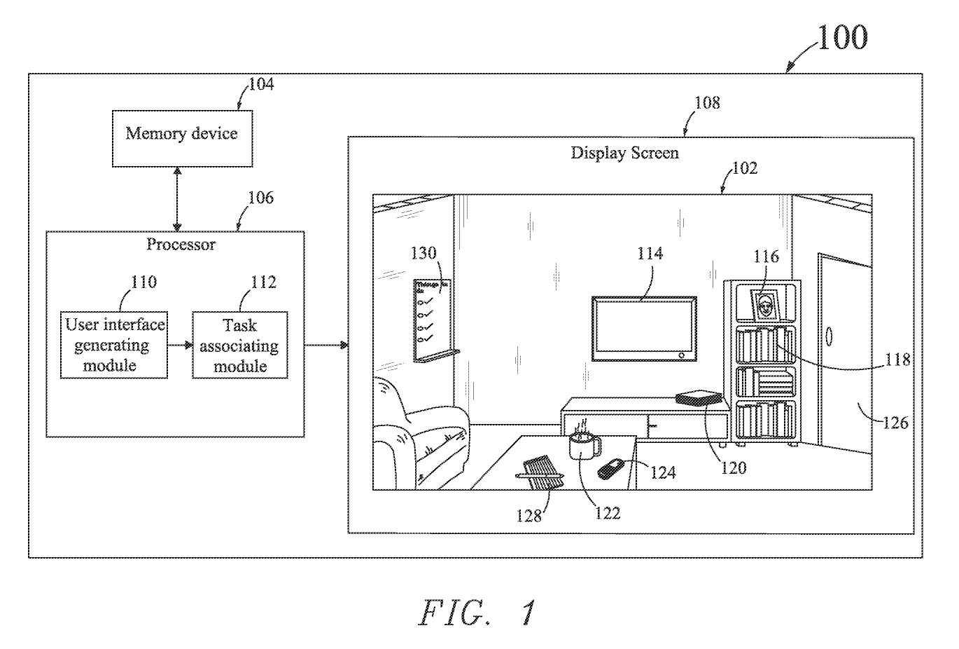

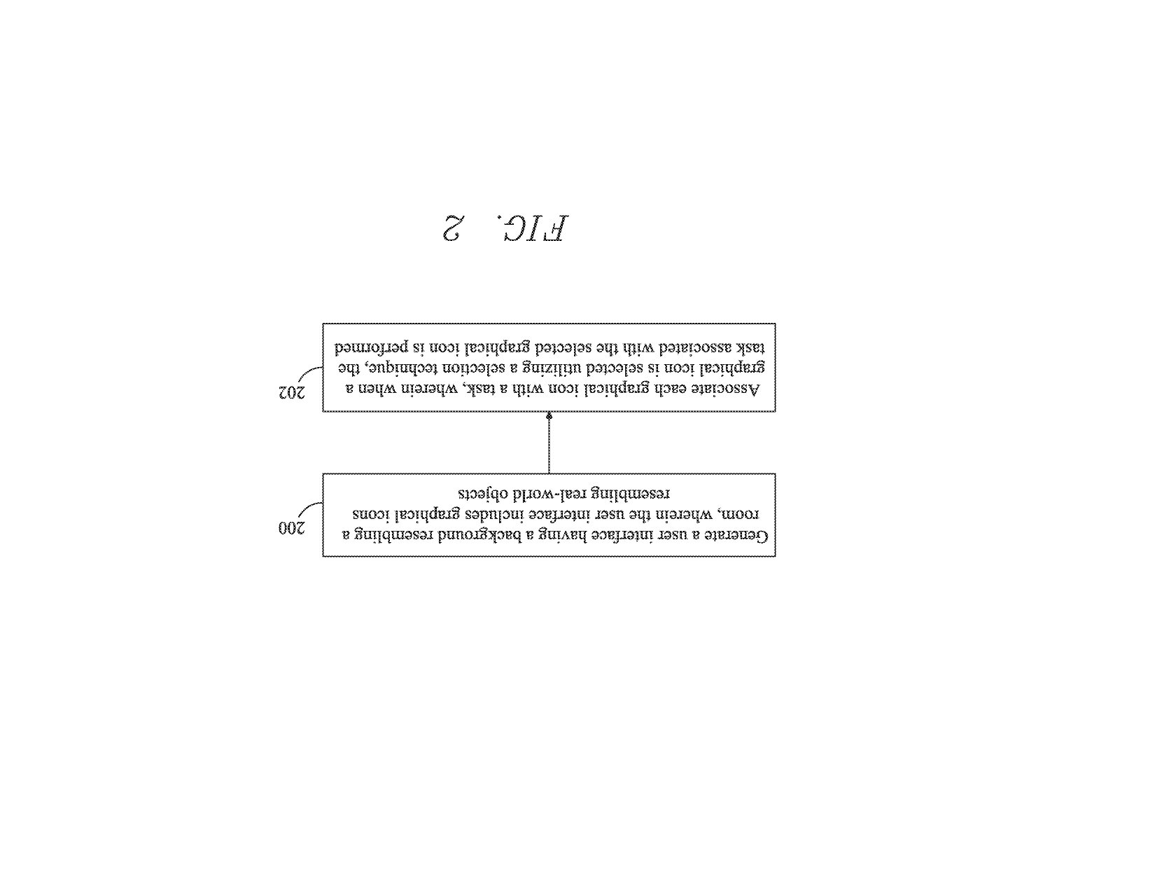

The present disclosure provides a method and a system for generating a user interface. The user interface may be displayed on a display screen of the system and may be used to perform certain tasks on the system. In one embodiment, the user interface resembles a room construct. Specifically, the user interface has a background that resembles a room of a building. Further, the user interface includes graphical icons which resemble real-world objects. The user interface would be very helpful to people who are not tech savvy. This is because the user interface would increase their adoption to the system naturally and would help them to easily operate the system to perform tasks of their choice, as will be explained in conjunction with FIGS. 1 and 2.

Referring to FIG. 1, a block diagram of a system 100 for generating a user interface 102 is shown, in accordance with an embodiment of the present disclosure. In one embodiment, the system 100 is an electronic device such as a computer; however in another embodiment the system may be a mobile phone or any other electronic device which has a display screen and needs a user interface.

The system 100 includes a memory device 104, a processor 106, and a display screen 108. The memory device 104 may be used to store programs and other data relevant to a user. The memory device 104 is coupled to the processor 106. The processor 106 includes a user interface (UI) generating module 110 and a task associating module 112. The UI generating module 110 generates the user interface 102 which may be stored in the memory device 104. Further, the user interface 102 may be displayed on the display screen 108 coupled to the processor 106. In one embodiment, the user interface 102 has a background which resembles a room of a building as shown in FIG. 1. However, in another embodiment, the user interface 102 may resemble any other real-life place or object.

In the present embodiment, the user interface 102 includes a plurality of graphical icons. The graphical icons resemble real-world objects such as a television 114, a photo frame 116, a book shelf 118, a magazine stack 120, a coffee mug 122, a mobile phone 124, a room door 126, a note pad 128, and a white board 130 as shown in FIG. 1. Each graphical icon resembling the real-world objects is associated with a task. Specifically, the task associating module 112 associates each graphical icon with a task which may be related to a real-world object. In one embodiment, upon selection of a graphical icon, the task associated with the selected graphical icon is performed. For example, a graphical icon which resembles a television 114 may be selected to play videos stored by the user in the memory device 104; a graphical icon which resembles a photo frame 116 may be selected to display still images stored by the user in the memory device 104; a graphical icon which resembles a book shelf 118 may be selected to display books and other reading content stored by the user in the memory device 104; a graphical icon which resembles a magazine stack 120 may be selected to display articles and discussion summaries stored by the user in the memory device 104; a graphical icon which resembles a coffee mug 122 may be selected to enter group conversations; a graphical icon which resembles a mobile phone 124 may be selected to enter chat rooms; a graphical icon which resembles a room door 126 may be selected to enter into a personalized one-on-one conversation, such as with a mentor; a graphical icon which resembles a note pad 128 may be selected to write a journal; and a graphical icon which resembles a white board 130 may be selected for preparing and tracking To-Do items.

It is to be understood that the user may update and dynamically change the books, reading content, articles, and discussion summaries in the memory device 104 as per the user's choice. Further, the tasks associated with the graphical icons may also be dynamically changed by the user or by a program developer. For example, the user may wish to associate the coffee mug 122 to coffee dates or to chat rooms instead of group conversations; or may wish to associate mobile phone 124 to telephonic conversations instead of chat rooms. Therefore, it is to be understood that the user may change tasks or add more tasks to the graphical icons.

In another embodiment, the graphical icons associated with the tasks may be dynamically changed either by the user or by a program developer. For example, the user may change the coffee mug 122 to a wine glass; and may associate the wine glass with group conversations. Therefore, it is to be understood that the user may change graphical icons or add more graphical icons to associate them with new or existing tasks.

In one embodiment, the user may utilize a selection technique to select a graphical icon. In one embodiment, when the system 100 is a computer, the user may use a mouse cursor to select a graphical icon in order to perform a desirable task. In another embodiment, when the display screen 108 is a touch screen, the user may directly touch the display screen 108 to select a graphical icon.

Referring now to FIG. 2, a flow chart representing a method for generating a user interface is shown, in accordance with an embodiment of the present disclosure. Specifically, at 200 a user interface having a background is generated, wherein the background of the user interface resembles a room. Further, the user interface includes graphical icons resembling real-world objects as mentioned above. At 202, each graphical icon is associated with a task, wherein when a graphical icon is selected utilizing a selection technique, the task associated with the selected graphical icon is performed.

It will be appreciated that embodiments of the disclosure described herein may comprise one or more conventional processors and unique stored program instructions that control the one or more processors to implement, in conjunction with certain non-processor circuits, some, most, or all functions of processing a sensor data. Alternatively, some or all functions of processing a sensor data could be implemented by a state machine that has not stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

As will be understood by those familiar with the art, the disclosure may be embodied in other specific forms without departing from the spirit or essential characteristics thereof. Likewise, the particular naming and division of the modules, agents, managers, functions, procedures, actions, methods, classes, objects, layers, features, attributes, methodologies and other aspects are not mandatory or significant, and the mechanisms that implement the disclosure or its features may have different names, divisions and/or formats. Furthermore, as will be apparent to one of ordinary skill in the relevant art, the modules, agents, managers, functions, procedures, actions, methods, classes, objects, layers, features, attributes, methodologies and other aspects of the disclosure can be implemented as software, hardware, firmware or any combination of the three. Of course, wherever a component of the present disclosure is implemented as software, the component can be implemented as a script, as a standalone program, as part of a larger program, as a plurality of separate scripts or programs, as a statically or dynamically linked library, as a kernel loadable module, as a device driver, and/or in every and any other way known now or in the future to those of skill in the art of computer programming. Additionally, the present disclosure is in no way limited to implementation in any specific programming language, or for any specific operating system or environment. Accordingly, the disclosure of the present disclosure is intended to be illustrative, but not limiting, of the scope of the disclosure, which is set forth in the following claims.

I/we claim:

1. A method, comprising
generating a user interface having a background, wherein the background resembles a room, and wherein the user interface includes graphical icons resembling real-world objects; and
associating each graphical icon with a task, wherein when a graphical icon is selected utilizing a selection technique, the task associated with the selected graphical icon is performed.

2. The method of claim 1, further comprising dynamically changing a task associated with a graphical icon by a user.

3. The method of claim 1, further comprising dynamically changing a graphical icon associated with a task by a user.

4. The method of claim 1, wherein the real-world object is a television, in which case the task associated with the graphical icon is to play videos.

5. The method of claim 1, wherein the real-world object is a photo frame, in which case the task associated with the graphical icon is to display still images.

6. The method of claim 1, wherein the real-world object is a book shelf, in which case the task associated with the graphical icon is to display reading content.

7. The method of claim 6, wherein the reading content is updated by a user.

8. The method of claim 1, wherein the real-world object is a magazine stack, in which case the task associated with the graphical icon is to display articles and summary of discussions.

9. The method of claim 8, wherein the articles and the summary of discussions are updated by a user.

10. The method of claim 1, wherein the real-world object is a coffee mug, in which case the task associated with the graphical icon is to invite a user for conversations.

11. The method of claim 1, wherein the real-world object is a mobile phone, in which case the task associated with the graphical icon is to invite a user to chat rooms.

12. The method of claim 1, wherein the real-world object is a room door, in which case the task associated with the graphical icon is to invite a user for personalized one-on-one conversation.

13. The method of claim 1, wherein the real-world object is a note pad, in which case the task associated with the graphical icon is to invite a user to write a journal.

14. The method of claim 1, wherein the real-world object is a white board, in which case the task associated with the graphical icon is to invite a user for preparing and tracking To-Do items. 20

15. A system, comprising
a display screen; and
a processor coupled to the display screen, the processor comprising:
a user interface generating module for generating a user interface having a background, wherein the background resembles a room, and wherein the user interface includes graphical icons resembling real-world objects; and
a task associating module for associating each graphical icon with a task, wherein when a graphical icon is selected utilizing a selection technique, the task associated with the selected graphical icon is performed.

16. A computer readable medium containing a computer program product, comprising:
program code for generating a user interface having a background, wherein the background resembles a room, and wherein the user interface includes graphical icons resembling real-world objects; and
program code for associating each graphical icon with a task, wherein when a graphical icon is selected utilizing a selection technique, the task associated with the selected graphical icon is performed.

17. The computer program product of claim 16, wherein the real-world object is a television, in which case the task associated with the graphical icon is to play videos.

18. The computer program product of claim 16, wherein the real-world object is a photo frame, in which case the task associated with the graphical icon is to display still images.

19. The computer program product of claim 16, wherein the real-world object is a book shelf, in which case the task associated with the graphical icon is to display reading content.

20. The computer program product of claim 16, wherein the real-world object is a white board, in which case the task associated with the graphical icon is to invite a user for preparing and tracking To-Do items.
